(19) United States
(12) Patent Application Publication
(10) Pub. No.: US 2019/0371486 A1
(43) Pub. Date: Dec. 5, 2019

(54) GRAPHITE COMPOSITE SHEET

(71) Applicant: UNICOH SPECIALTY CHEMICALS CO., LTD., Pohang-si (KR)

(72) Inventor: Bang Cha Rang SONG, Pohang-si (KR)

(21) Appl. No.: 16/369,033

(22) Filed: Mar. 29, 2019

(30) Foreign Application Priority Data
Jun. 1, 2018 (KR) 10-2018-0063332

(51) Int. Cl. H01B 1/24; C01B 32/20; C08J 5/18; C08J 5/00; H01B 3/44; B32B 9/00; B32B 9/04; B32B 27/20; B32B 27/32; B32B 27/30

(52) U.S. Cl. CPC H01B 1/24; B32B 2307/202; C08J 5/18; C08J 5/005; H01B 3/441; H01B 3/445; B32B 9/007; B32B 9/045; B32B 27/20; B32B 27/32; B32B 27/304; B32B 27/322; C01P 2006/40; C08J 2323/12; C08J 2323/06; C08J 2427/18; C08J 2427/16; B32B 2250/03; B32B 2250/40; B32B 2264/108; C01B 32/20

(57) ABSTRACT

The present invention introduces a graphite composite sheet including: a plurality of graphite layers; and a hot melt film layer interposed between the graphite layers, wherein the hot melt film layer includes a polymer made of PP (polypropylene) or PE (polyethylene); and a reinforcing agent consisting of graphite alone or of graphite and graphene.

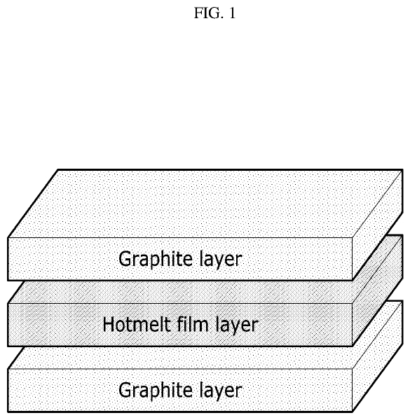

### TECHNICAL FIELD

The present invention relates to a graphite composite sheet. More specifically, the present invention relates to a graphite composite sheet having improved electrical conductivity.

### BACKGROUND OF INVENTION

Power saving technology increases capacity and reliability of efficiency, the power supply system of electricity use, introduced the expansion of large fluctuations of renewable energy over time, is an important technology for the efficient use throughout, including energy of a moving object Energy Regeneration its development the need for and the possibility of social contributions has been gradually increasing.

Looking at the properties required for the secondary battery used for a power storage capacity of energy storage density can be high, and flow cell is the most popular as the most appropriate for high capacity and high efficiency of the secondary battery in this characteristic.

In case of a graphite-utilizing sheet applied to a flow cell, it provides a flow path through which an anode and a cathode electrolyte may flow and plays a role of moving electrons, and thus has excellent corrosion resistance against an electrolytic solution and excellent electron mobility.

When a polymer is used for adhesion of a plurality of graphite sheets, very low vanadium ion permeability causes problems such as reduction of electric efficiency and capacity reduction.

### DESCRIPTION

### Problems to be Solved

The present invention provides a graphite composite sheet having excellent adhesion between graphite layers and improved electrical conductivity through a hot melt film layer including a polymer and a reinforcing agent consisting of graphite alone or of graphite and graphene.

### Means to Solve Problems

A graphite composite sheet according to an embodiment of the present invention may include a plurality of graphite layers; and a hot melt film layer interposed between said graphite layers, wherein the hot melt film layer includes a polymer of PP (polypropylene) or PE (polyethylene); and a reinforcing agent consisting of graphite alone or of graphite and graphene.

The hot melt film layer may further include an additive including at least one of Teflon and PVDF (Polyvinylidene fluoride).

The hot melt film layer may include 50 to 80% by weight of a reinforcing agent; and a residual polymer.

The hot melt film layer may include 70 to 80% by weight of a reinforcing agent; and a residual polymer.

The reinforcing agent may be composed of graphite and graphene, and the weight ratio of graphite and graphene may be 1:0.25 to 1:1.

The thickness of the hot melt film layer may be 100 to 200 μm.

The average particle diameter of graphite may be 50 μm or less.

The average particle diameter of graphene may be 10 μm or less.

### The Effects of Invention

The graphite composite sheet according to an embodiment of the present invention may be expected to have an excellent adhesion between graphite layers and an improved electrical conductivity through a hot melt film layer including a polymer and a reinforcing agent consisting of graphite alone or of graphite and graphene.

### BRIEF DESCRIPTION OF THE DRAWINGS

FIGURE illustrates a graphite composite sheet according to an embodiment of the present invention.

### DETAILED DESCRIPTIONS OF INVENTION

The terms first, second, third, and the like are used to describe various portions, components, regions, layers and/or sections, but are not limited thereto. These terms are only used to distinguish one portion, component, region, layer or section from another portion, component, region, layer or section. Thus, a first portion, component, region, layer or section described below may be referred to as a second portion, component, region, layer or section without departing from the scope of the present invention.

The terminology used herein is for the purpose of describing particular embodiments only and is not intended to limit the invention. The singular forms as used herein include plural forms as long as the phrases do not specifically state the opposite meaning thereof. The “comprises” means that a particular characteristic, region, integer, step, motion, element and/or component is specified and that does not exclude the presence or addition of other characteristics, regions, integers, steps, motions, elements, and/or components.

When referring to a part as being “on” or “above” another part, it may be positioned directly on or above another part, or another part may be interposed therebetween. In contrast, when referring to a part being “directly above” another part, no other part is interposed therebetween.

Unless defined otherwise, all terms including technical and scientific terms used herein have the same meaning as commonly understood by one of ordinary skill in the art to which the present invention belongs. Terms defined in the commonly used dictionary are further interpreted as having a meaning consistent with the relevant technical literature and the present disclosure, and are not to be construed as ideal or very formal meanings unless defined otherwise.

Hereinafter, embodiments of the present invention will be described in detail so that a person of ordinary skill in the art could easily carry out the present invention. The present invention may, however, be embodied in various forms and should not be construed as limited to the embodiments set forth herein.

### Graphite Composite Sheet

The graphite composite sheet according to an embodiment of the present invention may include a plurality of graphite layers and a hot melt film layer interposed between said graphite layers. The hot melt film layer may include a polymer of PP (Polypropylene) or PE (polyethylene) and a reinforcing agent consisting of graphite alone or of graphite and graphene.

The graphite layer is composed of a plurality of layers. The hot melt film layer is located between the graphite layers. When heat is applied, the graphite layers are attached as the hot melt film layer melts.

The hot melt film layer is made of a polymer of PP (polypropylene) or PE (polyethylene) as a matrix, and a reinforcing agent composed of graphite alone or of graphite and graphene is added thereto.

PP (Polypropylene) or PE (Polyethylene) is excellent in adhesion and may attach a plurality of graphite layers.

A reinforcing agent composed of graphite alone or of graphite and graphene is added to a polymer to improve electrical conductivity.

When the hot melt film layer is made of a polymer alone, the adhesion could be excellent, but due to little electric conductivity, the movement of electrons may be restricted. Therefore, the electric conductivity could be improved by adding graphite alone or graphite and graphene together which are excellent in electric conductivity. The hot melt film layer may have a thickness of 100 to 200 μm.

In the meantime, the hot melt film layer may further include an additive including at least one of Teflon and PVDF (polyvinylidene fluoride).

Teflon and PVDF (polyvinylidene fluoride) may be added to further improve electrical conductivity. However, if added excessively, the adhesion of the hot melt film layer may be insufficient.

Specifically, the hot melt film layer may include from 50 to 80% by weight of the reinforcing agent and the residual polymer. More specifically, it may comprise 70 to 80% by weight of the reinforcing agent and the residual polymer.

When the amount of the reinforcing agent is too small, the electric conductivity is extremely low so that the movement of electrons could be restricted. Thus, it may not be suitable for being used in the flow cell. On the other hand, if the reinforcing agent is added excessively, the electrical conductivity may be good, but the adhesion of the hot melt film layer may be reduced. Therefore, the content of the reinforcing agent added to the hot melt film layer may be controlled as mentioned in the above.

The polymer may include a hardener and a hardening accelerator in addition to PP (polypropylene) or PE (polyethylene).

More specifically, the reinforcing agent may be composed of graphite and graphene, and the weight ratio of graphite to graphene may be 1:0.25 to 1:1.

As the reinforcing agent, not only graphite alone but also graphene are added, the electric conductivity may be further improved. However, as the content of graphene increases, the effect of improving the electrical conductivity may not be large, but the manufacturing cost may increase.

Therefore, the weight ratio of graphite to graphene may be controlled to 1:0.25 to 1:1. More specifically, it may be 1:0.4 to 1:1. More specifically, it may be from 1:0.6 to 1:1.

Hereinafter, specific working examples of the present invention will be described. However, the following examples are only an embodiment of the present invention, and the present invention is not limited to the following examples.

### EXAMPLES

### Example 1

A graphite composite sheet in which a hot melt film layer was interposed between a plurality of graphite layers was prepared.

The hot melt film layer was prepared by adding graphite to PP (polypropylene). The thickness of the hot melt film layer was 150 μm. The average particle diameter of graphite was 50 μm or less.

The electrical resistance of the graphite composite sheet was determined upon changing the content of graphite to 50 wt. %, 60 wt. %, 70 wt. %, and 80 wt. %.

The electrical resistance values were determined, under specific voltage and current conditions, on one side and on the other side of the graphite composite sheet. The electrical conductivity of the graphite composite sheet was evaluated based on the electrical resistance values. The lower the electrical resistance value, the better the electrical conductivity of the graphite composite sheet.

The electrical resistance values of the graphite composite sheet according to one embodiment of the present invention are shown in Table 1 below.

TABLE 1

| | Graphite Content | | | |
|---|---|---|---|---|
| | 50 wt. % | 60 wt. % | 70 wt. % | 80 wt. % |
| Electrical Resistance | 4800 Ω | 1000 Ω | 90 Ω | 50 Ω |

As can be seen from the Table 1 above, the electrical resistance value was decreased as the content of graphite was increased. In particular, it could be understood that the electrical resistance value is remarkably decreased when the graphite content becomes 70 wt. % or more.

### Example 2

A graphite composite sheet was prepared under the same conditions as in Example 1, except that a hot melt film layer was prepared using PE (polyethylene) instead of PP (polypropylene).

The electrical resistance of the graphite composite sheet was determined upon changing the content of graphite to 50 wt. %, 60 wt. %, 70 wt. %, and 80 wt. %.

The electrical resistance values of the graphite composite sheet according to an embodiment of the present invention are shown in Table 2 below.

TABLE 2

| | Graphite Content | | | |
|---|---|---|---|---|
| | 50 wt. % | 60 wt. % | 70 wt. % | 80 wt. % |
| Electrical Resistance | 5500 Ω | 3500 Ω | 180 Ω | 80 Ω |

As can be seen from Table 2 above, the electrical resistance value was decreased as the content of graphite was increased. In particular, it could be understood that the electrical resistance value is remarkably decreased when the graphite content becomes 70 wt. % or more.

### Example 3

A graphite composite sheet was prepared under the same conditions as in Example 1, except that graphite as well as graphene were added together as a reinforcing agent. The ratio of graphite to graphene was 1:1. The average particle diameter of graphite was 50 μm or less and the average particle diameter of graphene was 10 μm or less.

The electrical resistance of the graphite composite sheet was determined upon changing the content of the reinforcing agent to 50 wt. %, 60 wt. %, 70 wt. %, and 80 wt. %.

The electrical resistance values of the graphite composite sheet according to one embodiment of the present invention are shown in Table 3 below.

TABLE 3

| | Reinforcing Agent (graphite + graphene) Content | | | |
|---|---|---|---|---|
| | 50 wt. % | 60 wt. % | 70 wt. % | 80 wt. % |
| Electrical Resistance | 1500 Ω | 500 Ω | 50 Ω | 10 Ω |

As can be seen from Table 3 above, the electrical resistance value was decreased as the content of the reinforcing agent (graphite+graphene) was increased. In particular, it could be understood that the electrical resistance value is remarkably decreased when the reinforcing agent (graphite+graphene) content becomes 70 wt. % or more. Further, it could be understood that the electrical resistance value is more excellent when graphene is added together than that of Example 1 in which only graphite is added.

### Example 4

A graphite composite sheet was prepared, under the same conditions as in Example 3, except that PE (polyethylene) was used instead of PP (polypropylene) to prepare the hot melt film layer.

The electrical resistance value of the graphite composite sheet was determined upon changing the reinforcing agent content to 50 wt. %, 60 wt. %, 70 wt. %, and 80 wt. %.

The electrical resistance values of the graphite composite sheet according to one embodiment of the present invention are shown in Table 4 below.

TABLE 4

| | Reinforcing agent (graphite + graphene) content | | | |
|---|---|---|---|---|
| | 50 wt. % | 60 wt. % | 70 wt. % | 80 wt. % |
| Electrical Resistance | 1500 Ω | 500 Ω | 50 Ω | 10 Ω |

As can be seen from Table 4 above, the electrical resistance value was decreased as the content of the reinforcing agent (graphite+graphene) was increased. In particular, it could be understood that the electrical resistance value is remarkably decreased when the content of the reinforcing agent (graphite+graphene) becomes 70 wt. % or more. Further, it could be understood that the electrical resistance value is more excellent when graphene is added together than that of Example 2 in which only graphite is added.

### Example 5

A graphite composite sheet in which a hot melt film layer was interposed between a plurality of graphite layers was prepared.

The hot melt film layer was prepared by adding graphite as well as graphene as a reinforcing agent to PP (polypropylene). The thickness of the hot melt film layer made of 80 wt. % of the reinforcing agent and residual polypropylene was 150 μm.

The electrical resistance of the graphite composite sheet was determined upon changing the weight ratio of graphite and graphene to 8:2, 7:3, 6:4, and 5:5.

The electrical resistance values of the graphite composite sheet according to one embodiment of the present invention are shown in Table 5 below.

TABLE 5

| Graphite Content | 80% | 70% | 60% | 50% |
|---|---|---|---|---|
| Graphene Content | 20% | 30% | 40% | 50% |
| Electrical Resistance | 150 Ω | 55 Ω | 15 Ω | 10 Ω |

As can be seen from Table 5 above, the electrical resistance value was decreased as the graphene content was increased.

### Example 6

A graphite composite sheet was prepared, under the same conditions as in Example 5, except that a hot melt film layer was prepared using PE (polyethylene) instead of PP (polypropylene).

The electrical resistance of the graphite composite sheet was determined upon changing the weight ratio of graphite and graphene to 8:2, 7:3, 6:4, and 5:5

The electrical resistance values of the graphite composite sheet according to one embodiment of the present invention are shown in Table 6 below.

TABLE 6

| Graphite Content | 80% | 70% | 60% | 50% |
|---|---|---|---|---|
| Graphene Content | 20% | 30% | 40% | 50% |
| Electrical Resistance | 350 Ω | 190 Ω | 80 Ω | 60 Ω |

As can be seen from Table 6 above, the electrical resistance value was decreased as the content of graphene was increased.

It would be understood by those skilled in the art that various changes in form and details may be made to the present invention and not limited to the embodiments and/or examples in the above. It would be understood that the invention may be embodied in other specific forms without departing from the technological idea or essential characteristics of the invention. It is therefore to be understood that the embodiments and/or the examples described above are illustrative in all aspects and not restrictive.

1. A graphite composite sheet comprising: a plurality of graphite layers; and
a hot melt film layer interposed between the graphite layers,
wherein the hot melt film layer comprises a polymer made of PP (polypropylene) or PE (polyethylene); and
a reinforcing agent consisting of graphite alone or of graphite and graphene.

2. The grahite composite sheet according to claim 1,
wherein the hot melt film layer further comprises an additive comprising at least one of Teflon and PVDF (polyvinylidene fluoride).

3. The graphite composite sheet according to claim 1,
wherein the hot melt film layer comprises 50 to 80% by weight of a reinforcing agent; and
a residual polymer.

4. The graphite composite sheet according to claim 1,
wherein the hot melt film layer comprises 70 to 80% by weight of a reinforcing agent; and
a residual polymer.

5. The graphite composite sheet according to claim 3,
wherein the reinforcing agent consists of said graphite and said grapheme,
wherein the weight ratio of graphite to graphene is 1:0.25 to 1:1.

6. The graphite composite sheet according to claim 1,
wherein the hot melt film layer has a thickness of 100 to 200 μm.

7. The graphite composite sheet according to claim 1,
wherein the graphite has an average particle diameter of 50 μm or less.

8. The graphite composite sheet according to claim 1,
wherein the graphene has an average particle diameter of 10 μm or less.
